(19) United States
(12) Patent Application Publication
(10) Pub. No.: US 2024/0008416 A1
(43) Pub. Date: Jan. 11, 2024

(54) CUTTING TOOL

(71) Applicant: PERENTI OUTDOOR TOOLS PTY LTD., Croydon (AU)

(72) Inventor: Danny ELMASRI, Bayswater (AU)

(21) Appl. No.: 18/472,927

(22) Filed: Sep. 22, 2023

Related U.S. Application Data
(63) Continuation-in-part of application No. PCT/AU2022/050263, filed on Mar. 23, 2022.

(30) Foreign Application Priority Data
Mar. 23, 2021 (AU) 2021900846

(51) Int. Cl. A01G 3/08; B26B 9/02; B26B 13/12

(52) U.S. Cl. CPC A01G 3/081; B26B 9/02; B26B 13/12

(57) ABSTRACT

A cutting tool for cutting brush, foliage, or branches in a swinging and pivotal cutting action includes a continuous elongated body having a handle at a first end, and at an opposing second end a cutting blade with a lower cutting edge, and a connecting part therebetween. The handle includes at least a first bulbous portion allowing the user to hold to form a pivot and by arm movement effect a swinging and pivotal cutting action.

### CROSS-REFERENCES TO RELATED APPLICATIONS

This application is a continuation-in-part (CIP) of PCT International Patent Application No. PCT/AU2022/050263 filed Mar. 23, 2022 which designated the U.S. and claims priority to Australian Patent Application No. 2021900846 filed Mar. 23, 2021, the entire contents of each of which are hereby incorporated by reference.

### FIELD OF THE INVENTION

The present invention relates to a cutting tool and in particular to a cutting tool that has a cutting blade with a lower cutting edge and is used for cutting brush, foliage, or branches in a cutting action, and will be described hereinafter with reference to this application. However, it will be appreciated that the invention is not limited to this particular field of use.

### BACKGROUND

A cutting tool for cutting brush, foliage, or branches can generally be of a scissor type and an elongated cutting type.

Elongated cutting type cutting tools includes scythes 11 such as shown in FIG. 1 in which a curved blade 12 at right angles and attached to the end of an elongated arm 13 which is held by the user by two spaced handles 14, 15 on the elongated arm 13. The first handle 14 is at the end of the elongated arm 13 distal to the blade which is held by a first hand of the user and the other hand is on the second handle 15 midway along the elongated arm 13. Thereby in use the scythe 11 is rotated around the user and the cutting by the scythe sweeping action is dependent on the inertia of the blade and the sweeping action. This type of cutting tool is therefore only useful for grasses or low density soft tall growth.

A further cutting type cutting tool is a machete 16 such as shown in FIG. 2. This cutting tool includes a heavy strong elongated blade 17 attached to a coextending small elongated handle 18. Due to the length and size and weight of the blade to provide the strength the centre of gravity (shown as C) along the blade is well beyond the dimensional longitudinal middle (shown as M) of the machete 16. Due to this extreme “blade heavy” construction the cutting tool is held tightly by all of the fingers and hand of the user and even in use resulting in the need of a strong slashing action by the entire forearm or even the entire arm the user to be able to hack cut denser brush, foliage, or branches. A machete can often have a weight in excess of 450 grams.

As a result of the relatively forward position of the centre of gravity, the machete generally operates efficiently only when using a swinging arm action. Efficiency of a traditional machete can therefore be negatively impacted if the working environment restricts arm movement of the user.

As a generalisation, bladed instruments have a relatively forward centre of gravity (toward the tip) when intended to be used with a swinging, cutting motion and a relatively backward (closer to the handle) centre of gravity when used in a stabbing or thrusting motion.

It can be seen that the problems with such known cutting tools includes one or more of:
a) Linear extension of the user arm
b) Requires a long cutting action and therefore full body action by the user
c) Is large heavy tool requiring strength of user to use
d) Requires strength merely to maintain in balance
e) Is limited in one form of cutting use
f) Is limited in what brush, foliage, or branches can be cut in a cutting action

The described embodiments seek to provide cutting tool, which will overcome or substantially ameliorate at least one or more of the deficiencies of the prior art, or to at least provide an alternative.

It is to be understood that, if any prior art information is referred to herein, such reference does not constitute an admission that the information forms part of the common general knowledge in the art, in Australia or any other country.

### SUMMARY OF THE INVENTION

According to a first aspect of the described embodiments, cutting tool is provided by a cutting tool for cutting brush, foliage, or branches in a swinging and pivotal cutting action comprising a continuous elongated body having a handle at a first end, and at an opposing second end a cutting blade with a lower cutting edge, and a connecting part therebetween wherein the handle includes at least a first bulbous portion allowing the user to hold to form a pivot and by arm movement effect a swinging and pivotal cutting action.

It can be seen that the invention of cutting tool provides the benefit of providing a different form of cutting without weight and unwieldiness of the prior art.

According to a second aspect of the described embodiments, cutting tool is provided by a method of cutting brush, foliage, or branches in a swinging and pivotal cutting action including the steps of:
a) Providing an elongated cutting tool having at least a blade with a continuous lower cutting edge;
b) Providing a pivoting handle bulbous portion to allow holding of the cutting tool to define a pivot;
c) Providing a centre of gravity of the cutting tool near the pivoting handle bulbous portion;
d) hold the cutting tool to form a pivot
e) and by arm movement effect a swinging and pivotal cutting action of the at least a blade with a continuous lower cutting edge.

The method of use of the cutting tool uses a swinging and pivotal cutting action is effected by a user wrist movement.

It can be seen that the invention of cutting tool provides the benefit of being versatile and ease of use.

According to a third aspect of the described embodiments, a cutting tool according to an embodiment of the invention is provided by a cutting tool including a housing formed by a cutting tool wherein the cutting blade is between 20 to 40% of the length of the cutting tool.

The handle of the cutting tool has at least a second bulbous portion further along the cutting tool than the first bulbous portion, wherein the second bulbous portion provides a stop to ensure the cutting tool does not slide out of the hand of the user in the effected swinging and pivotal cutting action.

The cutting tool has a weight of less than 100 grams with a length of greater than 50 centimetres but preferably has a weight of about 85 gram with a length of about 55 centimetres.

The cutting tool has a centre of gravity closer to the handle than the cutting blade and close to or at the first bulbous portion of the handle.

The cutting tool has at least one cutting blade which includes a lower concave curved blade and/or a lower convex curved blade.

The cutting tool includes at least one piercing hook at one end of a cutting blade.

It can be seen that the cutting tool can be substantially assembled with improving useability including any one or more of the following:
a) Improvements in flicking or pivoting action
b) Improvements in ease of handling

The tool further has the following unique features of:
1/ Blade specifically weighted so it can be very quickly accelerated and decelerated. Giving the user the ability make very quick snappy movements.
2/ Handle specifically designed for making quick snappy movements
3/ Handle specifically designed to be held in three main ways
   a/ used in the normal forward facing way
   b/ used in the 90 degree sideways method
   c/ holding by the rear ball giving greater reach and power (80% of work accomplished using methods b and c)

The tool further provides the Advantages of:
1/ Greater freedom of movement. Can hold and swing the tool in more ways than similar tools.
2/ The tool requires less energy to lift and swing.
3/ Can be decelerated and stopped much more easily.
4/ Can be used at furthest reach of the arm.
5/ gives the user better posture and doesn't swing the upper body off centre as much
6/ Reduces the frequency of changing feet position
7/ the tool can be used in a new and unusual way, which is to rotate the tool in the hand 90 degrees and use only the forearm assisted slightly with some swivelling of the upper arm to generate a very quick snappy motion. This is unique because when used in this way the wrist actually can not contribute anything to the motion like it does when a knife is used in the normal forward facing way.

Other aspects of the invention are also disclosed.

### BRIEF DESCRIPTION OF THE DRAWINGS

Notwithstanding any other forms which may fall within the scope of the described embodiments, preferred embodiments of the invention will now be described, by way of example only, with reference to the accompanying drawings in which:

FIG. 1 is a diagrammatic view of a prior art cutting tool of a scythe

FIG. 2 is a diagrammatic view of a prior art cutting tool of a machete

FIG. 3 is a diagrammatic side view of a cutting tool with a single lower concave curved blade for brush, foliage, or branches in a single cutting action;

FIG. 4 is a diagrammatic side view of a cutting tool with a single lower convex curved blade for brush, foliage, or branches in a single cutting action in accordance with a second preferred embodiment;

FIG. 5 is a diagrammatic side view of a cutting tool with a single lower concave curved blade for brush, foliage, or branches in a single cutting action and a single hooked tip in accordance with a third preferred embodiment;

FIG. 6 is a diagrammatic side view of a cutting tool with a double lower concave curved blade with opposing hooked tips at opposing ends of a first single lower concave curved blade for brush, foliage, or branches in a single cutting action in accordance with a fourth preferred embodiment;

FIGS. 7 and 8 are diagrammatic views of the cutting tools with a single lower curved blade of FIGS. 3 and 4 showing the centre of gravity along its length;

FIGS. 9 and 10 are diagrammatic views of the cutting tools with lower curved blades with hooked tips of FIGS. 5 and 6 showing the centre of gravity along its length;

FIG. 11 is a diagrammatic side view of the cutting tool with lower curved blades with hooked tips of FIG. 5 showing the holding contact points of the hand of the user on the handle;

FIGS. 12 and 13 are a diagrammatic side views of the cutting tool with a lower curved blade of FIG. 3 showing the pivoting operation around a holding contact point of the hand of the user on the handle;

FIG. 14 is a diagrammatic view of a method of use of a cutting tool for cutting brush, foliage, or branches in a single cutting action in accordance with another preferred embodiment;;

FIG. 15 is a diagrammatic view of another embodiment of cutting tool with a single lower cutting edge and a central handle portion;

FIG. 16 is a diagrammatic view of a further embodiment of a cutting tool with an alternative second bulbous portion;

FIGS. 17 to 19 are example side blade profiles of further embodiments of cutting tools;

FIG. 20 is a diagrammatic representation of a solid steel cutting tool according to a further embodiment;

FIGS. 21a to 21c are diagrammatic representations of a side, top and cross-sectional profile of a blade for a cutting tool in accordance with some embodiments;

FIG. 22 is phantom representation of a handle for a cutting tool according to some embodiments;

FIG. 23 is a diagrammatic representation of a handle for a cutting tool in accordance with some embodiments; and

FIGS. 24 to 27 are diagrammatic representations of an aluminium cutting tool according to a further embodiment.

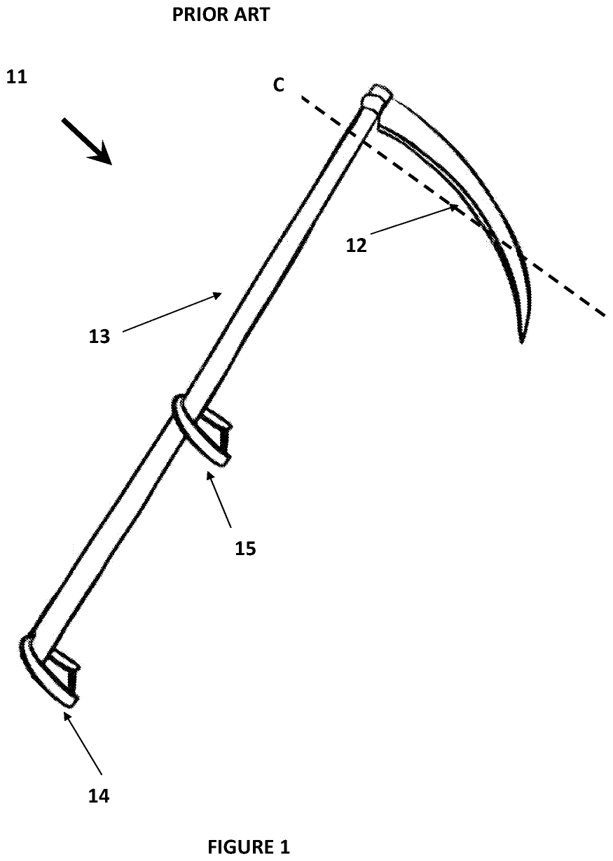

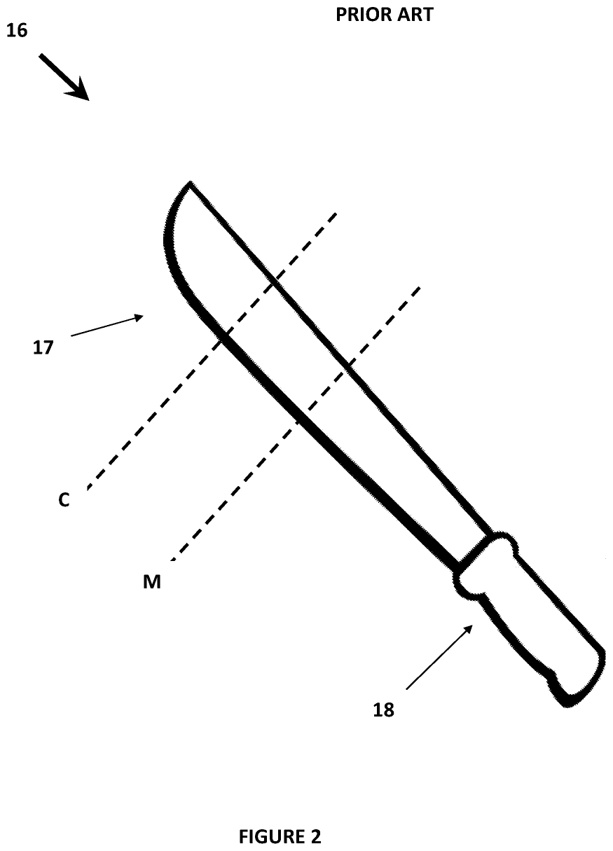

### DESCRIPTION OF PREFERRED EMBODIMENTS

It should be noted in the following description that like or the same reference numerals in different embodiments denote the same or similar features.

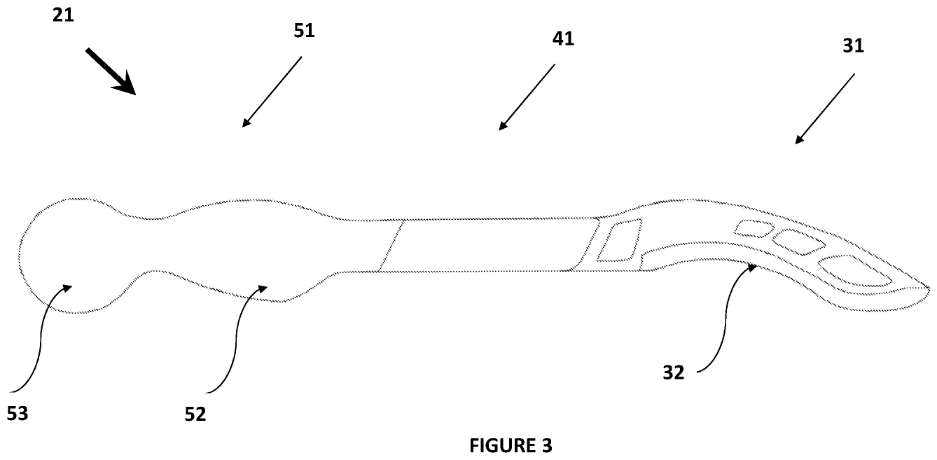

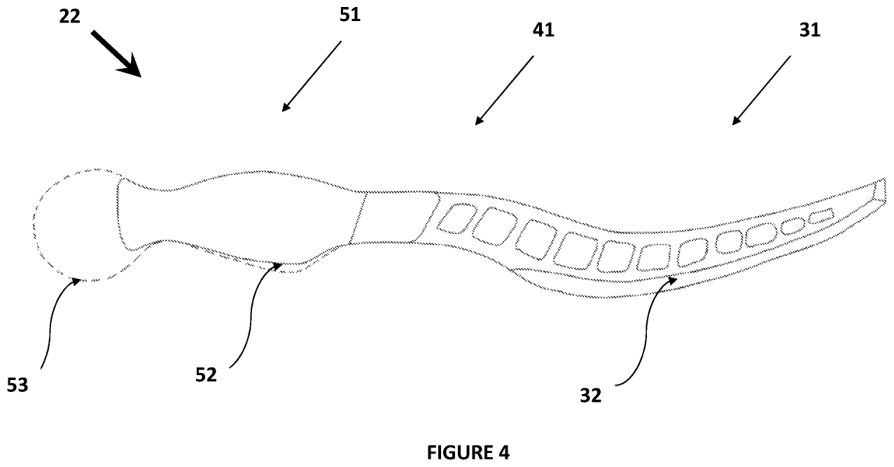

Referring to the drawings, and particularly FIGS. 3 and 4, there is shown a cutting tool 21, 22 in accordance with embodiments of the invention for cutting brush, foliage, or branches in a single cutting action in a swinging or pivotal cutting action.

The cutting tool 21, 22 of FIGS. 3 and 4 have a continuous elongated body having a handle 51 at a first end, and at an opposing second end a cutting blade 31 with a lower cutting edge 32, and a connecting part 41 therebetween.

The cutting tool is substantially linear in that it extends in a continuous elongated manner. The blade is formed of metal and has a honed, lower cutting edge.

In FIG. 3 that cutting edge is a shallow concave shaping while in FIG. 4 is cutting edge is a shallow convex shaping. The cutting blade may be between 20 to 40% of the length of the cutting tool.

For the examples of FIGS. 3 and 4 the handle includes a first bulbous portion 52 that extends on top and bottom of the handle allowing the user to hold loosely between the side of the first finger and the side of thumb to form a pivot and by primarily wrist movement effect a swinging and pivotal cutting action.

The handle 51 of the cutting tool 21, 22 has a second bulbous portion 53 further along and preferably at the end of the handle distal to the blade 31 the cutting tool than the first bulbous portion, wherein the second bulbous portion provides a stop to ensure the cutting tool does not slide out of the hand of the user in the effected swinging and pivotal cutting action.

Referring to FIGS. 3 to 6 the cutting tool, 21, 22, 23 or 24 according to various shown embodiments of the invention has a length of about 55 centimetres. The at least one cutting blade may include a lower concave curved blade or a lower convex curved blade.

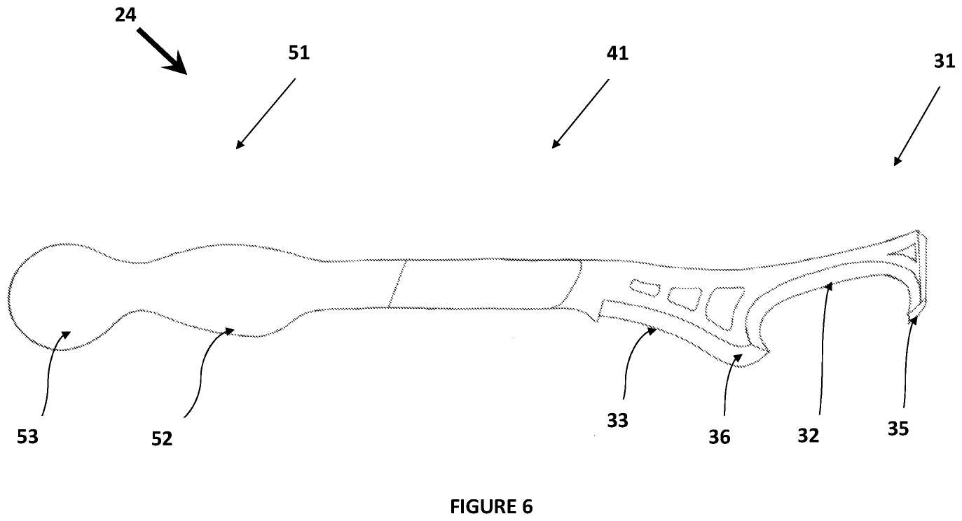

The cutting tool has at least one primary lower cutting blade 32 as shown in FIG. 3, 4 or 5 but can include a secondary lower blade 33 such as shown in FIG. 6.

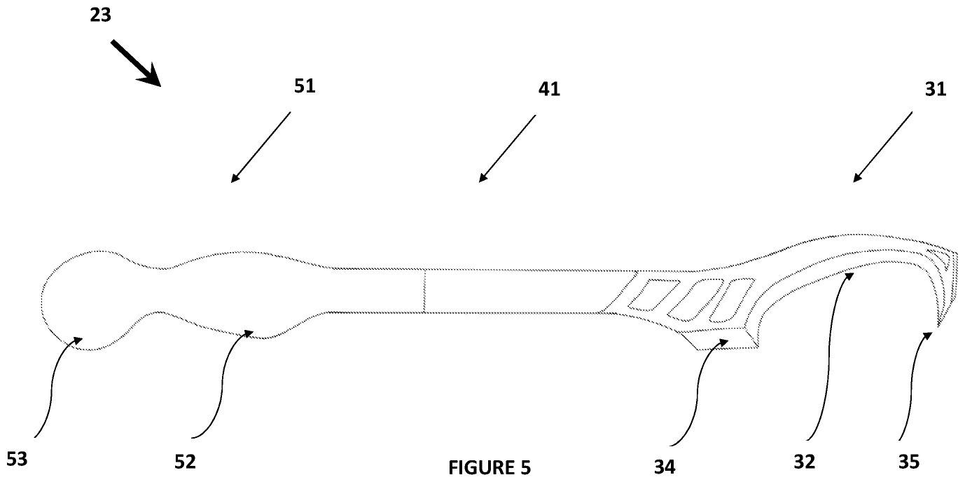

However, the cutting tool can further include at least one piercing hook 35 at one end of a cutting blade 32 as shown in FIGS. 5 and 6 and can even include a secondary piercing hook 36 at the opposed end of the primary cutting blade 32 as shown in FIG. 6 or include a flattened hammer 34 at that location as shown in FIG. 5.

The cutting tool has the primary cutting blade 32 one selected from:
a) a convex blade with a continuous lower cutting edge as shown in FIGS. 3, 5 and 6; or
b) a concave blade with a continuous lower cutting edge as shown in FIG. 4;

A multi blade with a convex blade with a continuous lower cutting edge and a convex blade with a continuous lower cutting edge;

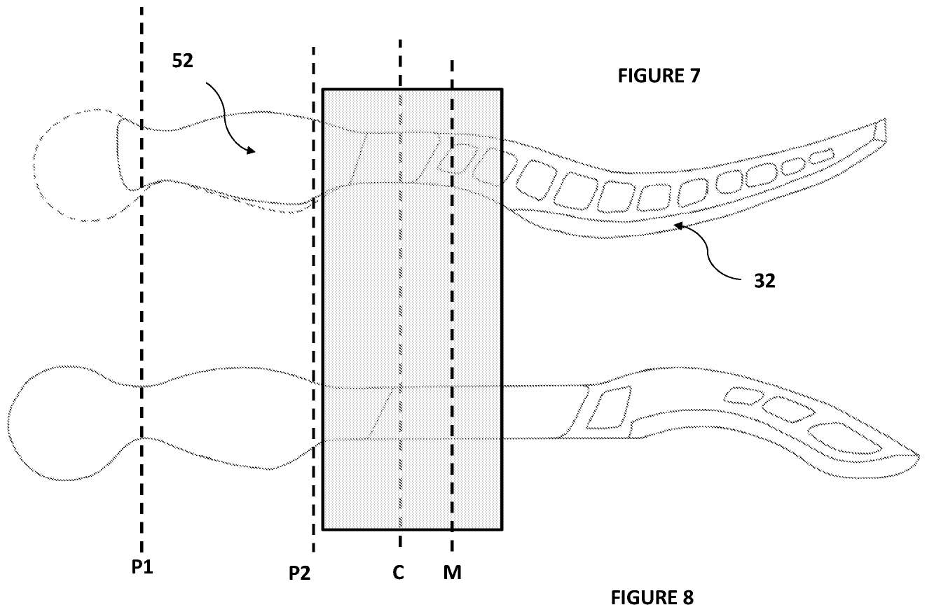

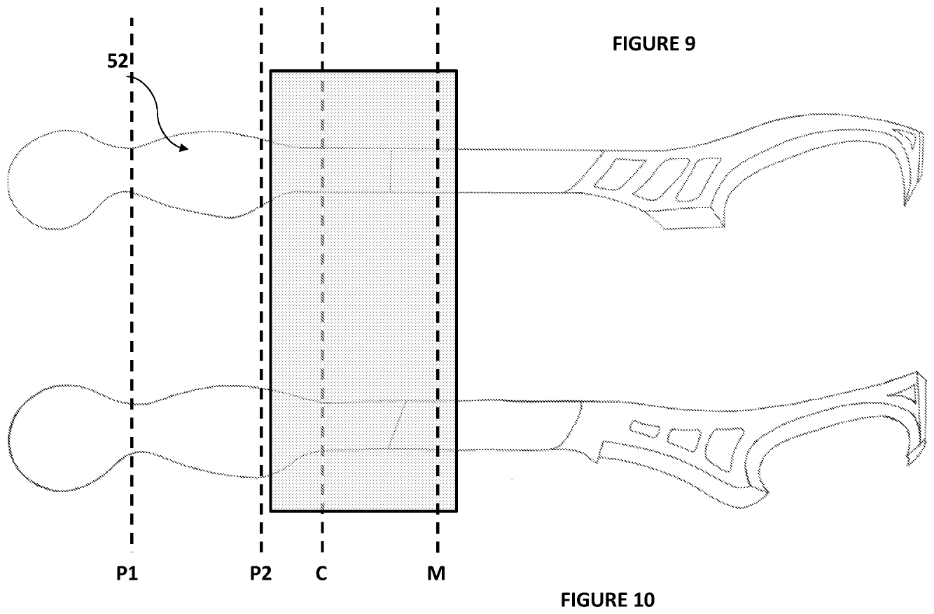

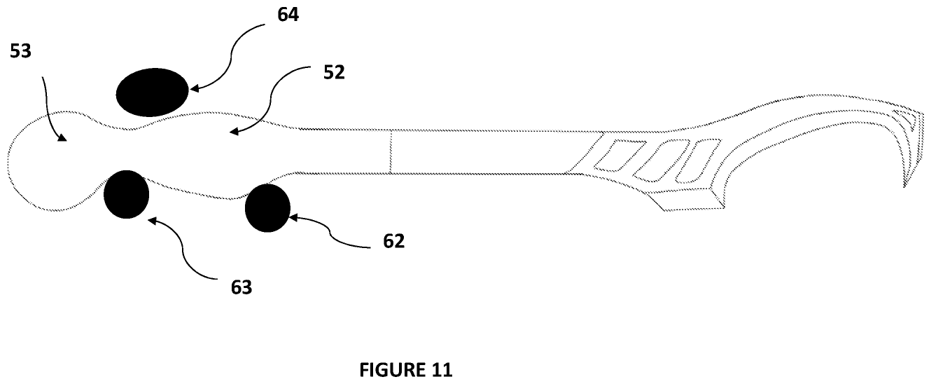

Referring to FIGS. 7 to 10 the cutting tool according to some embodiments has a centre of gravity C closer to the handle 51 than the cutting blade 32. The centre of gravity is substantially near a middle third of the elongated body. More particularly in some embodiments the centre of gravity C is on the handle side of the longitudinal middle M of the cutting tool and close to or at the first bulbous portion 52 of the handle 51.

The cutting blade may have at least one cutting blade extending along an elongated underside of the cutting tool.

It can be seen that there are a number of improved features which in different combinations provide different effects and have different benefits that each can provide novelty and inventiveness over the cutting tools of the prior art. The features include:
a) Weight range
b) Location of centre of gravity
c) Handle structure
d) Holding options
e) Usage options

The weight of blade to handle and overall weight is important to its use a in a flick snappy manner. The weight will be dependent on material used. Therefore a wooden handle tool will be different to a lighter plastic handle tool.

The weight (in gram) can be:

| | Handle | blade | Overall |
|---|---|---|---|
| Wood/metal | 100-150 | 110-150 | 210-270 |
| Plastic/metal | 60-120 | 70-150 | 130-270 |
| Metal/Metal | 100-130 | 140-170 | 240-270 |

In one example the cutting tool has length of about 55 centimetres with a blade weight of less than 100 grams and preferably about 85 grams. The centre of gravity is along the handle about a third of the length from the end of the handle and forming a pivot at the front of the first bulbous portion 52 of the handle 51.

The method of cutting brush, foliage, or branches in a swinging and pivotal cutting action including the steps of:
a) Providing an elongated cutting tool having at least a blade with a continuous lower cutting edge;
b) Providing a pivoting handle bulbous portion to allow holding of the cutting tool to define a pivot;
c) Providing a centre of gravity of the cutting tool near the pivoting handle bulbous portion;
d) hold the cutting tool to form a pivot and by arm movement effect a swinging and pivotal cutting action of the at least a blade with a continuous lower cutting edge.

The method of using the cutting tool includes a flicking or pivoting action wherein swinging and pivotal cutting action is effected by a user wrist movement and rotation around the pivot.

Also the tool can be used in a new and unusual way. Which is to rotate the tool in the hand 90 degrees and use only the forearm assisted slightly with some swivelling of the upper arm to generate a very quick snappy motion. This is unique because when used in this way the wrist does not contribute substantially to the motion as opposed to when a knife is used in the normal forward facing way.

This is a very important feature and can be an effective way to use the tool. A large portion of the work can be accomplished holding the tool in this way.

The tool in various embodiments have the following unique features
a) Blade specifically weighted so it can be very quickly accelerated and decelerated. Giving the user the ability make very quick snappy movements.
b) Handle specifically designed for making quick snappy movements
c) Handle specifically designed to be held in three main ways
d) used in the normal forward facing way
e) used in the 90 degree sideways method
f) holding by the rear ball (second bulbous portion) giving greater reach and power
   (it is suggested that 80% of work can be accomplished using methods b and c)

### Advantages

a) Greater freedom of movement. Can hold and swing the tool in more ways than similar tools.
b) The tool requires less energy to lift and swing.
c) Can be decelerated and stopped much more easily.
d) Can be used at furthest reach of the arm.
e) gives the user better posture and doesn't swing the upper body off centre as much
f) Reduces the frequency of changing feet position.

### Function of Operation

The cutting tool of the invention can include one or more operative features that alone or in combination can provide a substantial synergistic improvement in handling.

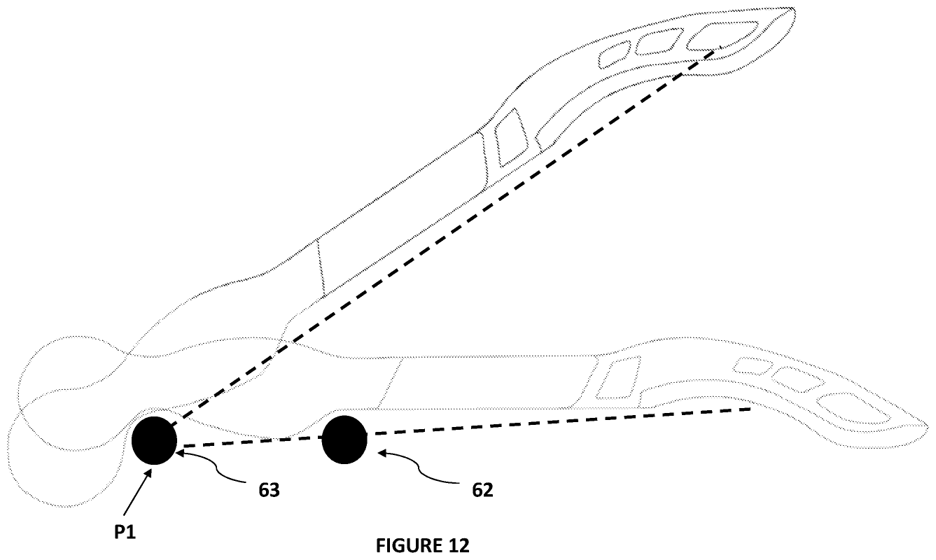

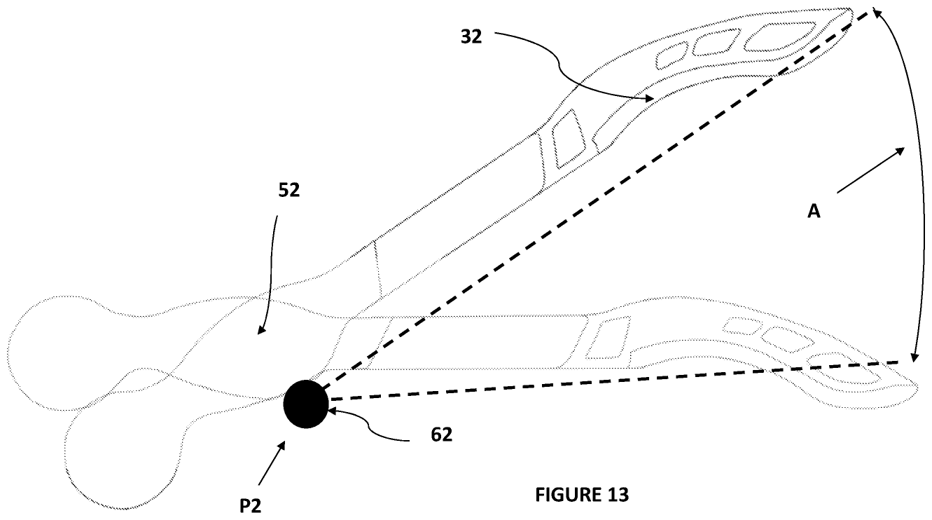

With reference for example to FIGS. 12 and 13 by a pivot point P1 being at the back of the handle of the cutting tool the user can hold the handle and by a wrist flip action provide a rotation of the cutting tool at the back finger or back grip of the hand and around the pivot point.

The weight is in one form spread so as to be about the middle M, of the cutting tool, as shown for example in FIGS. 7 to 10. This means operation will be unlike normal slashing machetes that have a centre of gravity relatively forward along the blade and thereby the angular momentum creates a great force and requires the whole user's forearm to hold and control. The weight being more about the middle M of the cutting tool means there is not a requirement to use the forearm but the flick pivot action caused by the wrist can provide a more effective whipping slash action.

Preferably the centre of gravity C of the weight distribution of the cutting tool is in front of the point P2 that is held by the user's forefinger or front of hand grip 63 on the handle of the cutting tool. In this way the angular momentum of the flick action around the back pivot point P1 tends the cutting tool to rotate and firmly engage the front of the hand in the flick cutting action. If the weight of centre of gravity C was behind this point and thereby between P1 and P2 the operation would feel “light” as the bulk of the weight would be resisting the flick action.

The cutting tools can have shapings at P1 and P2 in order to assist the holding and the pivoting action and the cutting operation.

It can be seen that having the weight of the centre of gravity C between the front pivot P2 and around the middle M of the elongated length of the cutting tool you are avoiding requiring a forearm basic strength control but instead allowing a wrist flick action.

This front pivot P2 can also provide more control so that instead of a simple vertical plane rotation of the cutting tool in a flick action by the user's wrist, the user can undertake supination and pronation of the wrist to allow flick slashing actions at lateral angles to the vertical.

There are various means to effect construction to obtain the required weight distribution to elongated length and location of the centre of gravity. However one substantial benefit is the inclusion of a central extension piece that can be a central handle so the user can hold the cutting tool in a different manner and obtain further variation in cutting technique.

Many other benefits of this novel and inventive cutting tool will be understood by a person skilled in the art.

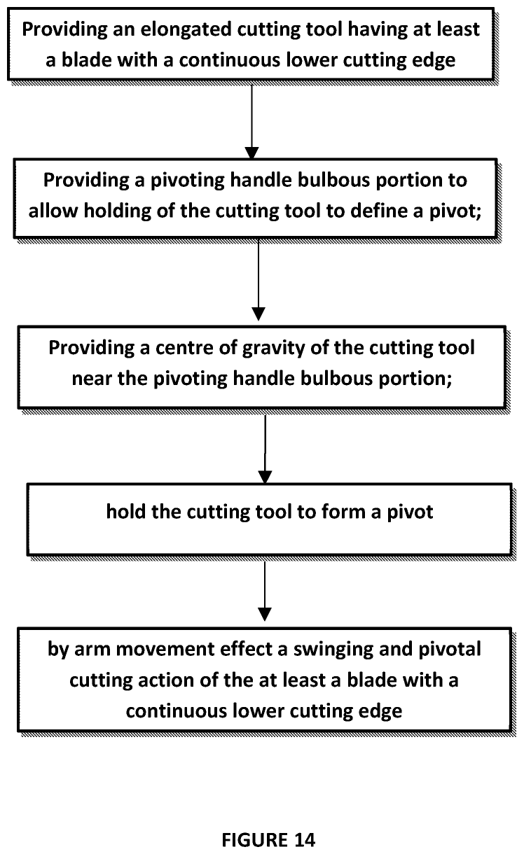

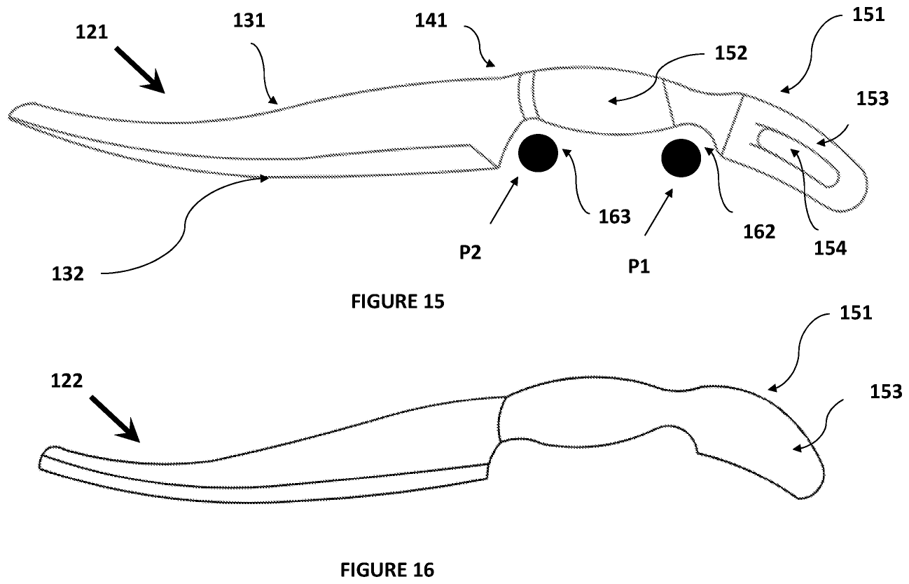

The distribution of weight further facilitates another way of operating the tool, wherein some embodiments of the cutting tool, as shown for example in FIGS. 14 and 15 can be operated by gripping the tool by the central extension piece, but rotating the hand such that the blade is substantially orthogonal relative to the user's forearm. Importantly, the described embodiments allow for effective cutting of brushes and foliage using supination and pronation of the arm while the blade is held in this manner, whereas traditional cutting tools are only effective when held in a specific orientation and operated using a motion requiring an extension of the arm.

In particular, a blade heavy machete may cause injury to a user if it is attempted to be used with supination and pronation movements, both due to the relatively forward centre of gravity, as well as the overall weight of traditional machetes. Advantageously, this alternative method of cutting allows the blade to be used where a user's freedom of arm movement is limited, for example, in dense brush or foliage.

The knife is specially designed to be held sideways, at 90 degrees to the conventional way similar cutting tools are used. And is to be utilised with a rotational movement of the arm. Rather than a backwards and forward motion as used with the currently available cutting tools.

When the knife is used in this way. It is a very different anatomical arrangement to the way typical machetes and similar tools are used. Instead of a muscular backwards and forwards motion the cutting tool is held sideways and used with an almost full 360 degrees worth of unhindered rotation.

Also, when the tool is held and used in this way the joints and ligaments in the arm are arranged in such a way that there is some elasticity that can be taken advantage of when striking with the cutting tool. this makes for very rapid and energy efficient striking. Especially if the cutting tool is not too heavy and is appropriately weighted.

The forearm muscles responsible for rotation are not as powerful as the muscles of the upper arm and therefore cannot use such a heavy knife. If the cutting tool is appropriately weighted and proportioned, the person operating the knife can take full advantage of the articulation of the arm, and elasticity of ligaments and joints when used with this method of operation.

The cutting tool is designed such that the weight is appropriately balanced so that it does not overwhelm the forearm muscles. And so that rapid acceleration and decelerating of the blade is achieved. Also, the weight of the tool does not strain and injury the wrist when rapidly decelerating the blade.

In addition, when the cutting tool is appropriately weighted to the user's personal strength. The user gains the benefit and ability to use some of the elasticity and “stretchiness” of the forearm to give some energy return or to contribute something to the movement of the blade. Similar to the way a runners calf muscles return some elastic propulsion in their stride. Resulting in a very rapid and energy efficient method of striking with the cutting tool.

### EXAMPLES

Referring to FIG. 15 a cutting tool 121 is shown in accordance with an example embodiment of the invention. The cutting tool 121 has a continuous elongated body having a handle 151 at a first end, and at an opposing second end a cutting blade 131 with a lower cutting edge 132, and a connecting part 141 therebetween.

The cutting tool 121 is substantially linear in that it extends in a continuous elongated manner. The blade 131 is formed of metal and has a honed, lower cutting edge 132. The cutting blade is approximately 50% of the length of the cutting tool.

The handle includes a first bulbous portion 152 forming a central extension piece allowing the user to hold the cutting tool loosely in the palm of the hand between the location of the forward finger 163 and the location of a back finger 162 to form a first pivot P1. As a result, a swinging and pivotal cutting action can be performed by primarily wrist movement, wherein the cutting tool rotates about the back finger of the user at P1.

The weight of the cutting tool 121 is distributed such that the centre of gravity of the tool is located substantially near the longitudinal middle of the elongated body. Specifically, the centre of gravity for the embodiment shown is slightly forward (toward the tip) from the longitudinal middle of the elongated body. Advantageously, by having the centre of gravity nearer to the middle as opposed to traditional blade heavy cutting tools, the cutting tool can be operated using the wrist instead of requiring the additional strength of a user's forearm, upper-arm, and shoulder.

For example, the cutting tool 121 may be weighted such that the combination of blade 131, including the connecting part 141 and tang (not shown) protruding into the handle 151 has a weight of approximately 220 grams, with a wooden or plastic grip of the handle having a weight of approximately 50 grams. Duch that the overall weight of the cutting tool is approximately 270 with the centre of gravity

As a result, the centre of gravity is located forward of the position of the forward finger 163 to allow some angular momentum to be generated when flicking and pivoting the blade 131 about both P1 and P2. Due to reduced overall weight, and weight distribution of the cutting tool 121 the first bulbous portion 152 can be held relatively loosely such that in performing a flicking action the cutting tool 121 can further be allowed to pivot around the forward finger of the user at P2 enabling sharp quick cuts to be executed with limited or no arm movement.

For the example embodiment shown, the handle 151 comprises a second bulbous portion 153 which performs a two-fold operation. When the user is gripping the handle 151 by the first bulbous portion 152, the second bulbous portion 153 provides a stop preventing the cutting tool from sliding out of the user's hand when performing the cutting action.

Additionally the user can grip the cutting tool 121 by the second bulbous portion 153 to perform a swinging cutting action with relatively greater angular moment because the second bulbous portion 153 is spaced further away from the centre of gravity of the elongate body. For the embodiment shown, when gripping the second bulbous portion, the location of rear finger 162 when gripping the first bulbous portion 152 forms a recess for receiving a forward finger of the user to assist in preventing the cutting tool 121 from sliding from the user's hand when performing the cutting action. For example, the second bulbous portion may form an angled pistol grip. In addition to helping to prevent slippage, an angled pistol grip may further assist a user in extending the blade and performing the cutting action without requiring extensive radial or ulnar displacement of the wrist.

For the embodiment shown in FIG. 15 the second bulbous portion 153 defines an aperture 154. The aperture 154 may be formed in the handle to reduce the weight of the handle 151 as well as the weight distribution of the handle 151. Aperture 154 may also be used as an attachment for, for instance, suspending or clipping the cutting tool when not in use.

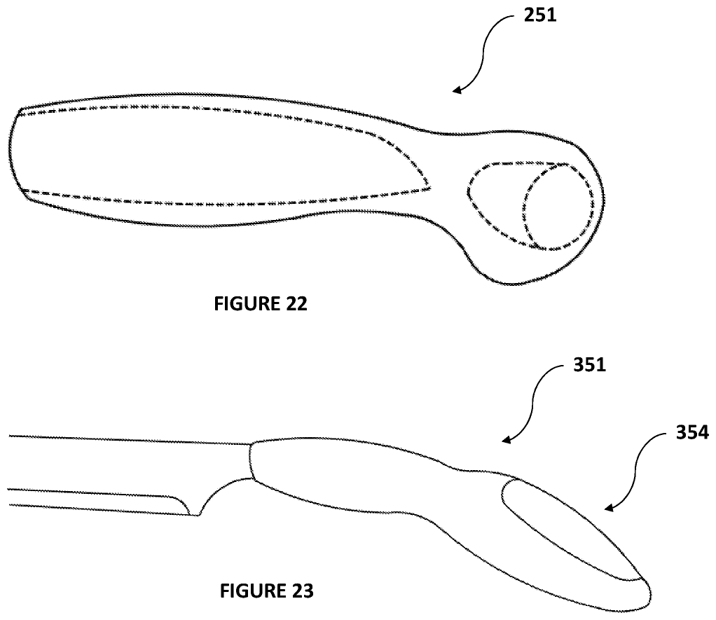

Referring to FIG. 16, the second bulbous portion 153 may be solid, or alternatively, as shown for example in FIGS. 22 and 23 the second bulbous portion may be formed as hollow or include an aperture 354 to reduce the weight of the handle which in turn impacts the location of the centre of gravity of the cutting tool.

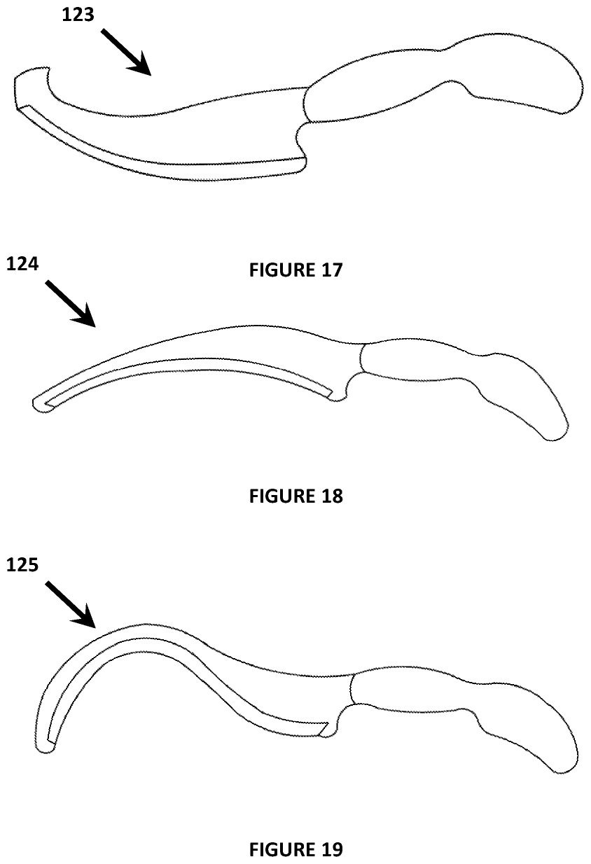

FIGS. 17 to 19 show further embodiments of cutting tools 123, 124, 125 with varying blade profiles with convex and/or concave side blade profiles. Importantly, while the shape of the blade may be varied depending on application, for instance, the brush or foliage to be cut, the centre of gravity for each of the embodiments is relatively near the longitudinal middle of the elongated body.

### Further Embodiment

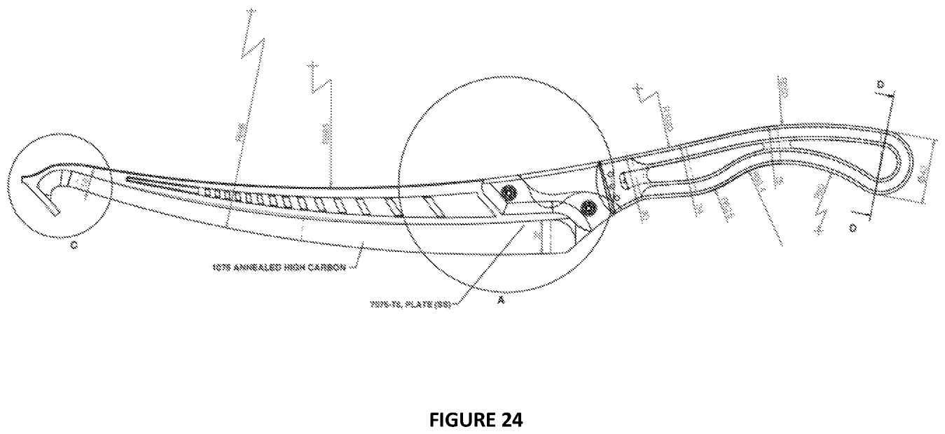

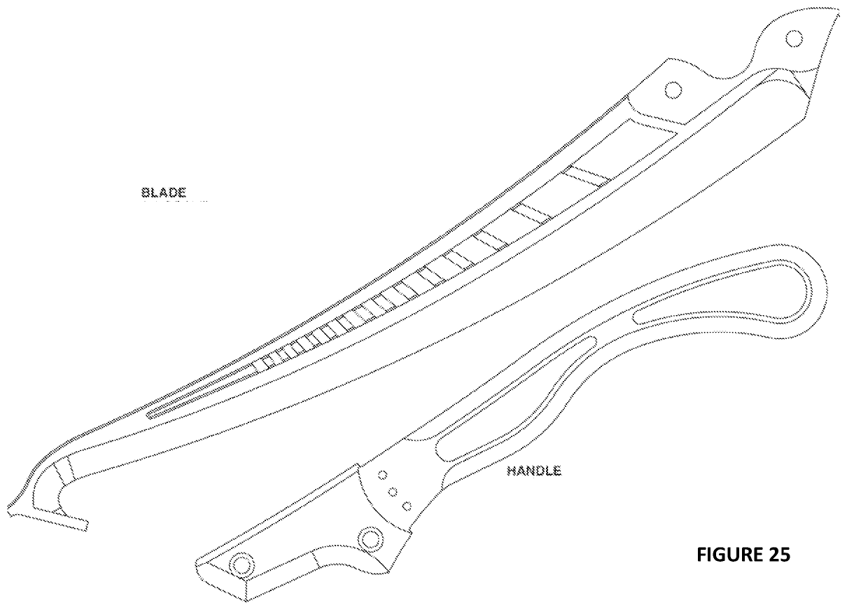

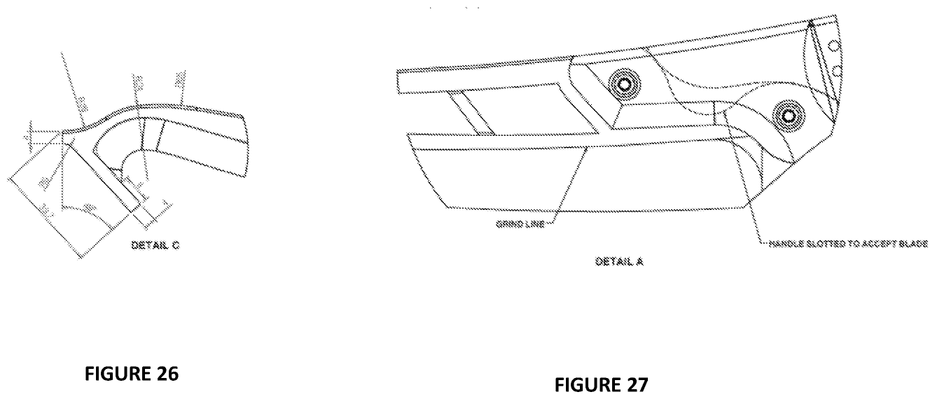

With reference to FIGS. 24 to 27, the cutting tool in this embodiment is constructed in a way that is quite unlike any other knife. It utilises a frame made from aircraft grade aluminium in place of a full tang construction. in this way, a very light weight but immensely strong and robust cutting tool can be constructed. The cutting tool typically weighs approximately the same as a tennis racket or even less. Yet it is still strong enough to chop and spit wood. And is sufficiently robust enough to cope with this sort of high impact work.

The cutting tool utilises a tang made from aluminium alloy to offer greater wall thickness for the same amount of weight as if it were solid steel full tang construction. The aluminium tang/handle frame offers greater volume, wall thickness and strength than the equivalent weight in steel.

The handle frame permits a very secure attachment line for the handle components. Enabling stock removal from inside the handle. While reinforcing it and maintaining strength.

The aluminium frame taking the place of the tang also brings the benefit that the blade steel is no longer integrated into the handle. And so is external. And the blade can be removed and replaced.

### Blade Design

### Solid Steel Blades

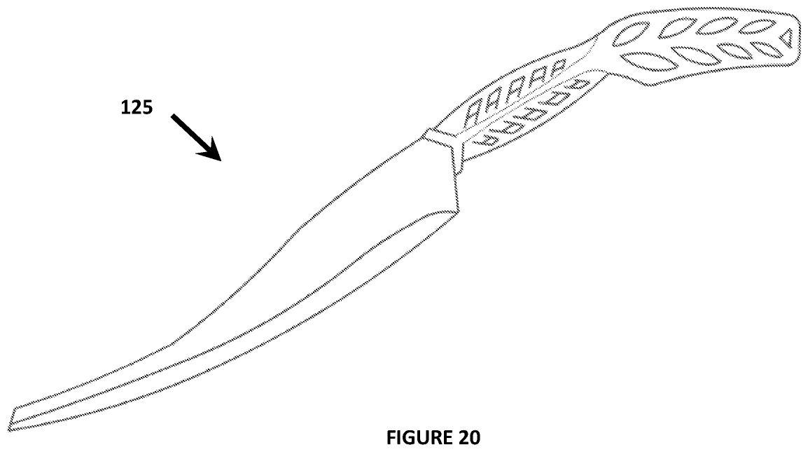

Referring for example to FIG. 20 the cutting tool may be formed by precision cutting a solid metal to form the blade, tang, and/or handle. The preferred weight distribution may be achieved by removing sections of the handle or tang portion of the cutting tool. Advantageously, the sections can be removed not only to regulate weight distribution, but further to provide adornment and other visual features as shown.

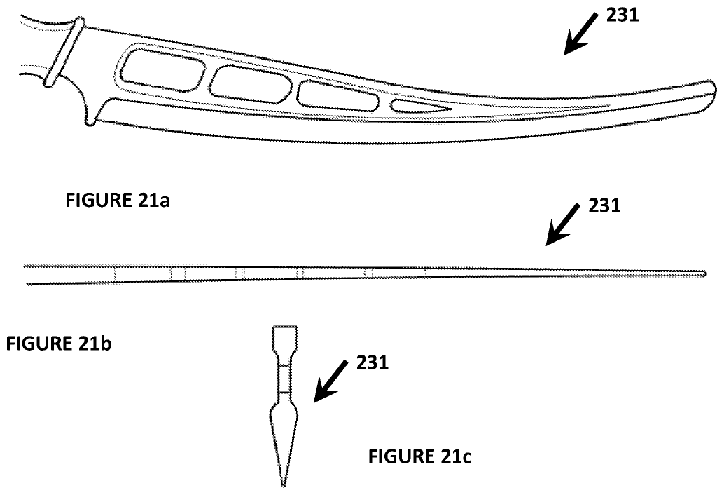

Referring to FIG. 21a to FIG. 21c, the weight distribution of the cutting tool may further be regulated by altering physical characteristics of the blade. Physical characteristics of the blade include side profile, cross sectional profile, and construction materials. For the example shown, the weight of the blade is reduced by fullering a middle section 280 of the blade and/or by removing sections or skelotonising the blade to form apertures 281 within the blade in order to reduce the weight of the blade.

### Composite Blades

The weight characteristics of the blade may also be altered by using different types of materials to form the blade. For example, only the cutting edge of the blade may be steel of a grade necessary to perform the cutting action. The remainder of the blade may be of a different material, for example, lighter material to reduce the overall weight of the cutting tool.

In some embodiments, the cutting blade may comprise high carbon spring steel or a hardened steel that is attached to an aluminium or titanium alloy subframe. For example, the cutting tool may comprise independent parts joined to make up the cutting tool including, a cutting blade, a subframe, which may include a partial or full tang, and a gripping portion. The subframe and tang combination may have a weight of approximately 115 grams. The cutting blade may have a weight of approximately 95 grams. The gripping portion may have a weight of approximately 50 grams. The overall weight of the cutting tool will as a result be approximately 270 grams.

The cutting blade may be connected to the subframe using a braced spine method, wherein the alloy subframe comprises a skeletonised spine having two parallel parts, and wherein the steel blade is frictionally retained between the parallel parts.

Optionally the cutting blade and the subframe may be joined using various metal joinery techniques. For example the cutting blade and subframe may be joined by a rivetted connection. The rivets may be slightly offset such that the subframe is deformed as the rivets are connected. As a result, an internal ridge of the cutting blade may be placed under tension which may improve elasticity characteristics of the blade.

### Handle Design

### Injection Moulding

The total weight and weigh distribution of the handle will impact the overall weight and centre of gravity of the cutting tool. The weight of handle is impacted by various factors including, the material and density of the grip, and the material, density and form of the tang of the blade engaging with the grip.

In some embodiments, the handle portion of the cutting tool may be injection moulded and shaped to cooperatively engage with an end of the cutting blade. Referring to FIGS. 22 and 23, for example the handle 251 may be shaped or moulded to receive and retain a tang 242 of the cutting blade 31, 131, 231. The injection moulding process may comprise forming the the first bulbous portion and the second bulbous portion of the handle. The handle may be moulded to form one or more voids 254 within the handle to reduce the weight of the handle and adjust the centre of gravity of the elongated body.

### Interpretation

### Embodiments

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly, it should be appreciated that in the above description of example embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description of Specific Embodiments are hereby expressly incorporated into this Detailed Description of Specific Embodiments, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

### Different Instances of Objects

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

### Specific Details

In the description provided herein, numerous specific details are set forth. However, it is understood that embodiments of the invention may be practiced without these specific details. In other instances, well-known methods, structures and techniques have not been shown in detail in order not to obscure an understanding of this description.

### Terminology

In describing the preferred embodiment of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar technical purpose. Terms such as “forward”, “rearward”, “radially”, “peripherally”, “upwardly”, “downwardly”, and the like are used as words of convenience to provide reference points and are not to be construed as limiting terms.

### Comprising and Including

In the claims which follow and in the preceding description of the invention, except where the context requires otherwise due to express language or necessary implication, the word “comprise” or variations such as “comprises” or “comprising” are used in an inclusive sense, i.e. to specify the presence of the stated features but not to preclude the presence or addition of further features in various embodiments of the invention.

Any one of the terms: including or which includes or that includes as used herein is also an open term that also means including at least the elements/features that follow the term, but not excluding others. Thus, including is synonymous with and means comprising.

### Scope of Invention

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the described embodiments.

Although the invention has been described with reference to specific examples, it will be appreciated by those skilled in the art that the invention may be embodied in many other forms.

### Industrial Applicability

It is apparent from the above, that the arrangements described are applicable to the cutting brush, foliage, or branches in horticultural or gardening or bushwalking or the like industries.

1. A cutting tool for cutting brush, foliage, or branches in a swinging and pivotal cutting action comprising
a. a continuous elongated body having a handle at or near a first end, and at an opposing second end a cutting blade with a lower cutting edge, and a connecting part therebetween
b. wherein the handle includes at least a first bulbous portion allowing the user to hold to form a pivot and by arm movement effect a swinging and pivotal cutting action around the pivot.

2. A cutting tool according to claim 1 wherein the first bulbous portion allows the user to hold the cutting tool to form a first pivot at a back finger of the user to effect a pivotal cutting action about the back finger.

3. A cutting tool according to claim 1 wherein the elongated body is weighted to have a centre of gravity near a longitudinal middle of the elongated body.

4. A cutting tool according to claim 3 wherein the centre of gravity of the elongated body is located within the middle 33 percent of the length of the elongated body.

5. A cutting tool according to claim 1 wherein the cutting blade is between 20 to 50% of the length of the cutting tool.

6. A cutting tool according to claim 2 wherein the handle of the cutting tool has a second bulbous portion further along the cutting tool than the first bulbous portion, wherein the second bulbous portion provides a stop to ensure the cutting tool does not slide out of the hand of the user in the effected swinging and pivotal cutting action when gripping the first bulbous portion wherein the second bulbous portion allows the user to hold the cutting tool to form a second pivot at a front finger of the user to effect a continuing pivotal cutting action about the forward finger of the user.

7. The cutting tool according to claim 1 wherein the elongated body is weighted to have a centre of gravity near a longitudinal middle of the elongated body wherein the centre of gravity is relatively forward of the second pivot.

8. The cutting tool according to claim 1 wherein the centre of gravity is located between the longitudinal middle of the elongated body and the second pivot.

9. A cutting tool according to claim 1 wherein the cutting tool has a weight of about 130 to 270 grams.

10. A cutting tool according to claim 1 wherein the cutting tool has a length greater than 50 centimetres.

11. A cutting tool according to claim 1 wherein the cutting tool has a centre of gravity closer to the handle than the cutting blade.

12. A cutting tool according to claim 1 wherein the cutting tool has a centre of gravity close to the first bulbous portion of the handle.

13. A cutting tool according to claim 1 wherein the cutting blade has at least one cutting blade extending along an elongated underside of the cutting tool.

14. A cutting tool according to claim 1 wherein the at least one cutting blade includes a lower concave curved blade.

15. A cutting tool according to claim 1 wherein the at least one cutting blade includes a lower convex curved blade.

16. A cutting tool according to claim 1wherein the second bulbous portion allows the user to grip the handle relatively away from a centre of gravity of the elongated body to increase angular momentum of the cutting tool when swinging the cutting tool.

17. A cutting tool according to claim 16 wherein a connection between the first bulbous portion and the second bulbous portion forms a grip for a forward finger of a user's hand when gripping the second bulbous portion to help prevent the cutting tool from sliding out of the hand of the user when performing a swinging arm action.

18. A method of cutting brush, foliage, or branches in a swinging and pivotal cutting action including the steps of:
a. providing an elongated cutting tool having at least a pivoting handle and a blade with a lower cutting edge;
b. providing the pivoting handle with a first bulbous portion to allow holding of the cutting tool to define a first pivot near a rear of the pivoting handle;
c. providing a centre of gravity of the cutting tool near the pivoting handle bulbous portion;
d. hold the cutting tool to form a pivot;
e. and by arm movement effect a swinging and pivotal cutting action of the at least a blade with a continuous lower cutting edge
and wherein swinging and pivotal cutting action is effected by a user wrist movement.

19. A method of cutting according to claim 18 wherein the handle of the cutting tool has a second bulbous portion further along the cutting tool than the first bulbous portion, wherein the second bulbous portion provides a stop to ensure the cutting tool does not slide out of the hand of the user in the effected swinging and pivotal cutting action when gripping the first bulbous portion wherein the second bulbous portion allows the user to hold the cutting tool to form a second pivot at a front finger of the user to effect a continuing pivotal cutting action about the forward finger of the user.

20. A cutting tool according to claim 1 having a tang and interfitting securely attached handle made from aluminium alloy wherein the aluminium frame taking the place of the tang allowing the blade steel to no longer be integrated into the handle and thereby is external and can be removed and replaced.
